(19) United States
(12) Patent Application Publication
(10) Pub. No.: US 2013/0166261 A1
(43) Pub. Date: Jun. 27, 2013

(54) SPECIFICITY QUANTIFICATION OF BIOMOLECULAR RECOGNITION AND ITS APPLICATION FOR DRUG DISCOVERY

(71) Applicants: Zhiqiang Yan, Stony Brook, NY (US); Jin Wang, South Setauket, NY (US)

(72) Inventors: Zhiqiang Yan, Stony Brook, NY (US); Jin Wang, South Setauket, NY (US)

(21) Appl. No.: 13/722,233

(22) Filed: Dec. 20, 2012

Related U.S. Application Data
(60) Provisional application No. 61/579,891, filed on Dec. 23, 2011.

(51) Int. Cl. G06F 19/12

(52) U.S. Cl. CPC G06F 19/12
USPC 703/2

(57) ABSTRACT

A novel scoring function called SPA takes account of both specificity and affinity of highly efficient and specific protein-ligand binding. The method to develop SPA is based on the funneled energy landscape theory and employs affinity and specificity of biomolecular interactions. The quantified specificity of the native protein-ligand complex, which discriminates against “non-native” binding modes, and the affinity prediction are simultaneously optimized during the development. SPA is obtained by maximizing the specificity and affinity prediction of a large training set of “native” protein-ligand complexes with known structures and affinities. SPA can be employed to discriminate drugs from the diversity set, or to discriminate selective drugs from non-selective drugs. The remarkable performance of SPA makes it promising to be implemented in the docking software and widely applied in virtual screening for seeking the lead compounds.

### CLAIM OF PRIORITY

This application claims the benefit of priority from U.S. Provisional Application No. 61/579,891 filed with the United States Patent and Trademark Office on Dec. 23, 2011.

### STATEMENT REGARDING FEDERALLY SPONSORED RESEARCH OR DEVELOPMENT

This invention was made with government support under grant number MCB0947767 awarded by the National Science Foundation. The government has certain rights in the invention.

### FIELD OF THE INVENTION

The present invention relates to a method of modeling highly efficient and specific biomolecular recognition between protein and ligands and a system for implementing the same

### BACKGROUND OF THE INVENTION

Biomolecular recognition is central to cellular processes mediated by the formation of complexes between biomolecular receptors and their ligands. Understanding of biomolecular recognition is one of the most important issues in modern molecular biology and has direct applications in drug discovery and design. The fast and accurate prediction of a ligand specifically binding to a target protein is a crucial step for lead discovery. During the past two decades, considerable efforts have been devoted to the development of docking algorithms and scoring functions. There are many docking algorithms available; however, imperfections of scoring functions continue to be a major limiting factor.

Highly efficient and specific biomolecular recognition requires both affinity and specificity. The stability of the complex is determined by the affinity while the specificity is controlled by either partner binding to other competitive biomolecules discriminatively. The current scoring functions of protein-ligand binding, whether force-field based, empirical, or knowledge-based scoring functions, are mainly focused on improving the ability of predicting the known binding affinities observed in experiments as accurately as possible. The strategy of developing these scoring functions seeks to optimize the stability based on the combination of energetics and shape complementarity without explicit consideration of binding specificity.

However, high affinity does not guarantee high specificity which is critical for function, e.g. drug-target recognition. To design a drug, one has to design a lead compound binding to a specific target receptor rather than others indiscriminately for avoiding the possible side effects.

According to the Boltzman distribution (P˜exp[−E/k_{B}T]), the equilibrium population is exponentially dependent on the binding free energy. A gap in binding free energy or affinity will lead to significant population discrimination between the specific complex and non-specific ones. Thus to develop a scoring function, the strategy should satisfy the requirement that the stability of the specific complex is maximized while the stability of competing complexes is minimized, which can guarantee both the stability and the specificity for the specific complex.

In previous models for predicting biomolecular recognition, specificity was not taken into account explicitly because description of binding specificity was challenging to quantify. The conventional definition of specificity is the ability of a ligand to specifically bind to a protein against other proteins, namely the relative difference in affinity of one specific protein-ligand complex to others. The quantification of conventional specificity is challenging since specificity requires comparison of the affinities of all the different receptors with the same ligand. The receptor universe is huge and the information is often incomplete on those proteins.

### SUMMARY OF THE INVENTION

A novel scoring function called SPA takes account of both specificity and affinity of highly efficient and specific protein-ligand binding. The method to develop SPA is based on the funneled energy landscape theory and employs affinity and specificity of biomolecular interactions. The quantified specificity of the native protein-ligand complex, which discriminates against “non-native” binding modes, and the affinity prediction are simultaneously optimized during the development. SPA is obtained by maximizing the specificity and affinity prediction of a large training set of “native” protein-ligand complexes with known structures and affinities. SPA can be employed to discriminate drugs from the diversity set, or to discriminate selective drugs from non-selective drugs. The remarkable performance of SPA makes it promising to be implemented in the docking software and widely applied in virtual screening for seeking the lead compounds.

A method for highly efficient and specific biomolecular recognition is based on a funneled energy landscape theory and employs affinity and specificity for biomolecular reactions. The quantified specificity of the native protein-ligand complex, which discriminates against non-native binding modes, and the affinity prediction are simultaneously optimized. This method can be employed to discriminate drugs from a diversity set, or to discriminate selective drugs from non-selective drugs. A novel scoring function called SPA takes account of both specificity and affinity of protein-ligand binding. SPA can be employed to simultaneously reach the maximization of specificity and affinity for a large training set of “native” protein-ligand complexes with known structures and affinities. By introducing adjustable coefficients of potentials calibrated for optimizing with both specificity and affinity, SPA offers an effective way to circumvent the calculation of the reference state which is a longstanding issue in the development of knowledge-based scoring functions.

According to an aspect of the present disclosure, a method of generating a scoring function for quantifying characteristics of protein-ligand bindings is provided. The method includes steps of: generating an initial form of a scoring function that represents a quantity derived from a total intermolecular energy of each protein-ligand complex by providing different weighting to each type of atom pair potentials; generating an average intrinsic specificity ratio that is a ratio of an energy gap between an energy of a native conformation and an average energy of the ensemble of decoys to a width of energy distribution of the ensemble of decoys; generating an affinity correlation coefficient between a set of experimentally measured values of affinity and a set of predicted values of affinity as generated from the scoring function; generating a combination parameter that strictly increases with any increase in the intrinsic specificity ratio and with any increase in the affinity correlation coefficient; iteratively modifying the scoring function, the intrinsic specificity ratio, and the affinity correlation coefficient by changing values of the different weighting of atom pair potentials; and finalizing a functional form of the scoring function by accepting final values of the different weighting when the iterative modification results in a convergence. At least one step of the generation of the scoring function, the generation of the average intrinsic specificity ratio, the generation of the affinity correlation coefficient, the generation of the combination parameter, and the iterative modification of the scoring function, the intrinsic specificity ratio, and the affinity correlation coefficient is performed employing a computing system including one or more processors in communication with a memory.

According to another aspect of the present disclosure, a method of characterizing affinity and specificity of each compound bound to a target protein is provided. The method comprises providing a finalized scoring function employing a method described above, and determining a score for each selected lead compound employing the finalized form of the scoring function. Compounds with high scores can be subsequently identified as lead compounds, for example, by selecting the lead compounds having scores greater than a predetermined threshold value or by selecting a preset number of lead compounds having highest scores.

According to even another aspect of the present disclosure, a system for generating a scoring function for quantifying characteristics of protein-ligand bindings is provided. The system includes one or more processors in communication with a memory and is configured to run a computer program. The computer program includes steps of: generating an initial form of a scoring function that represents a quantity derived from a total intermolecular energy of each protein-ligand complex by providing different weighting to each type of atom pair potentials; generating an average intrinsic specificity ratio that is a ratio of an energy gap between an energy of a native conformation and an average energy of the ensemble of decoys to a width of energy distribution of the ensemble of decoys; generating an affinity correlation coefficient between a set of experimentally measured values of affinity and a set of predicted values of affinity as generated from the scoring function; generating a combination parameter that strictly increases with any increase in the intrinsic specificity ratio and with any increase in the affinity correlation coefficient; iteratively modifying the scoring function, the intrinsic specificity ratio, and the affinity correlation coefficient by changing values of the different weighting of atom pair potentials; and finalizing a functional form of the scoring function by accepting final values of the different weighting when the iterative modification results in a convergence.

According to yet another aspect of the present disclosure, a system for characterizing affinity and specificity of each compound bound to a target protein is provided. The system comprises the system for providing a finalized scoring function described above. The system further comprises another computer or another program in the system described above for determining a score for each selected lead compound employing the finalized form of the scoring function. Compounds with high scores can be subsequently identified as lead compounds, for example, by selecting the lead compounds having scores greater than a predetermined threshold value or by selecting a preset number of lead compounds having highest scores.

According to still another aspect of the present disclosure, a computer program product for generating a scoring function for quantifying characteristics of protein-ligand bindings is provided. The computer program product is embodied in a non-transitory machine readable medium and embodying a computer program. The computer program includes steps of: generating an initial form of a scoring function that represents a quantity derived from a total intermolecular energy of each protein-ligand complex by providing different weighting to each type of atom pair potentials; generating an average intrinsic specificity ratio that is a ratio of an energy gap between an energy of a native conformation and an average energy of the ensemble of decoys to a width of energy distribution of the ensemble of decoys; generating an affinity correlation coefficient between a set of experimentally measured values of affinity and a set of predicted values of affinity as generated from the scoring function; generating a combination parameter that strictly increases with any increase in the intrinsic specificity ratio and with any increase in the affinity correlation coefficient; iteratively modifying the scoring function, the intrinsic specificity ratio, and the affinity correlation coefficient by changing values of the different weighting of atom pair potentials; and finalizing a functional form of the scoring function by accepting final values of the different weighting when the iterative modification results in a convergence. At least one step of the generation of the scoring function, the generation of the intrinsic specificity ratio, the generation of the affinity correlation coefficient, and the generation of the combination parameter, and the iterative modification of the scoring function, the intrinsic specificity ratio, and the affinity correlation coefficient is performed employing a computing system including one or more processors in communication with a memory.

According to further another aspect of the present disclosure, a computer program product for characterizing affinity and specificity of each compound bound to a target protein is provided. The computer program product comprises the computer program product for providing a finalized scoring function described above. The computer program product further comprises another program for determining a score for each selected lead compound employing the finalized form of the scoring function. Compounds with high scores can be subsequently identified as lead compounds, for example, by selecting the lead compounds having scores greater than a predetermined threshold value or by selecting a preset number of lead compounds having highest scores.

### BRIEF DESCRIPTION OF THE DRAWINGS

FIG. 1A schematically illustrates the concept of conventional specificity as relative affinity of a ligand against multiple receptors.

FIG. 1B schematically illustrates a new view of specificity as a degree of preference, by a ligand binding on a specific and native binding site over other binding sites on a single receptor.

FIG. 1C schematically illustrates the new view of specificity as a degree of preference, by a universe of different ligands binding on a specific and native binding site over other binding sites on a single receptor.

FIG. 2A is a schematic view of multiple docking complex conformations including the “native” pose and the decoys.

FIG. 2B is an illustration of the density of states as a function of energy. The vertical direction corresponds to the energy level of a state, and each state is schematically illustrated as a line.

FIG. 2C is the corresponding distribution of binding energies.

FIG. 2D is a schematic diagram of a funnel energy landscape illustrating the energy and entropy of various states of the protein-ligand binding.

FIG. 3A is a first part of a flowchart that illustrates steps of the Specificity and Affinity (SPA) method according to the present disclosure.

FIG. 3B is a second part of the flowchart that illustrates steps of the SPA method according to an embodiment of the present disclosure.

FIG. 4 illustrates evolution and convergence of parameters ρ, λ and γ in the Monte Carle (MC) simulations according to an embodiment of the present disclosure.

FIG. 5A is an enrichment curve that demonstrates that the selective drugs are obviously separated from the diversity set, while the non-selective drugs are weakly separated from the diversity set.

FIG. 5B is a result of the statistical discrimination by the Kolmogorov-Smirnov (KS) test.

FIG. 5C is a two-dimensional projection of specificity and affinity based on the performance of the SPA method on the screening.

FIG. 6 is illustration of an exemplary system configured to perform the various steps of the present disclosure.

### DETAILED DESCRIPTION OF THE INVENTION

As stated above, the present invention relates to a method of modeling highly efficient and specific biomolecular recognition between protein and ligands and a system for implementing the same. It is noted that like and corresponding elements mentioned herein and illustrated in the drawings are referred to by like reference numerals. It is also noted that proportions of various elements in the accompanying figures are not drawn to scale to enable clear illustration of elements having smaller dimensions relative to other elements having larger dimensions.

Highly efficient and specific biomolecular recognition requires both affinity and specificity. Previous quantitative descriptions of biomolecular recognition focused on the affinity prediction, but did not employ any quantification of specificity. A novel method referred to as the “SPA method” (Specificity and Affinity) method is disclosed herein, which is based on the funneled energy landscape theory. In this method, a strategy to simultaneously optimize the quantified specificity of the “native” protein-ligand complex discriminating against “non-native” binding modes and the affinity prediction is employed. The benchmark testing of the SPA method of the present disclosure demonstrated the best performance against 16 other popular known scoring functions employed in industry and academia on both prediction of binding affinity and “native” binding pose. For the target COX-2 of nonsteroidal anti-inflammatory drugs, SPA method successfully discriminated the drugs from the diversity set, and the selective drugs from non-selective drugs. The remarkable performance demonstrates that SPA method has significant potential applications in identifying lead compounds for drug discovery.

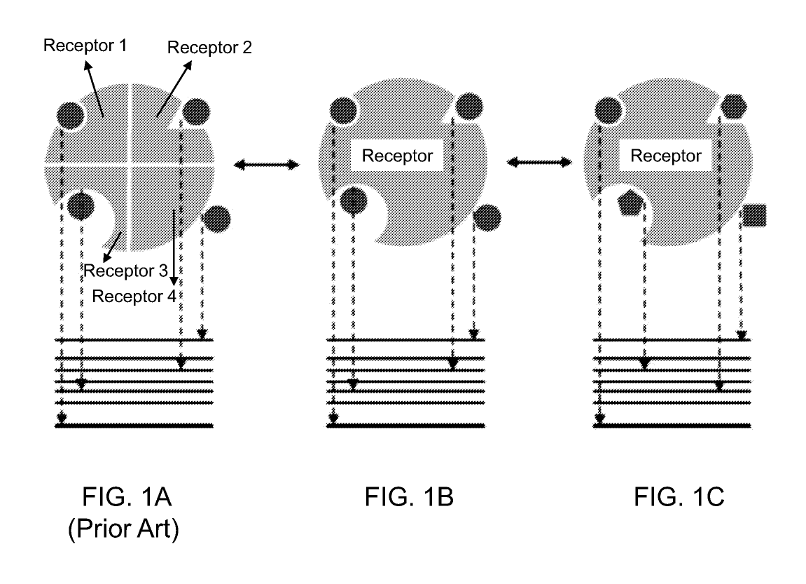

Referring to FIG. 1A, the conventional definition of specificity as relative affinity against multiple receptors on a single protein is illustrated.

Referring to FIG. 1B, a new view of specificity employed in this disclosure is schematically illustrated, which is defined as the preference of a ligand binding onto the specific site of a single receptor over other binding sites on the same receptor. The assumption is that a ligand binding to many protein receptors is equivalent to its binding to them with N and C terminus of these protein receptors linked together, leading to binding to an effectively large protein. Therefore, if the target protein is large enough, one can think of it as composed of many different segments each mimicking a protein receptor. The conventional specificity as relative affinity against different receptors now becomes intrinsic specificity of the native binding mode against the other binding modes for this large target protein.

Referring to FIG. 1C, another view of specificity employed in this disclosure is illustrated. One receptor protein with different sites binding with a ligand is similar to the case of the whole universe of different ligands binding with the same receptor. If the protein target size is large enough, then the spatial contact interactions can be sampled enough to cover all the contact interactions appearing in the ligand binding to different receptors.

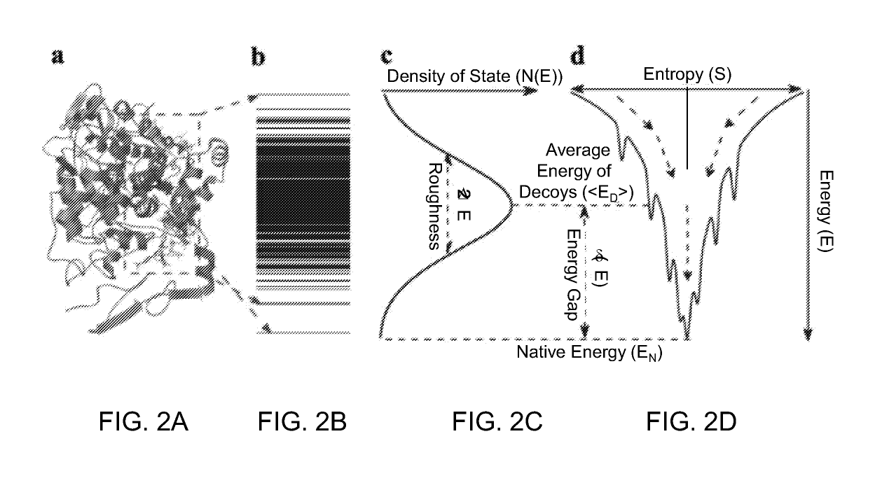

Similar to protein folding, the binding process of protein-ligand can be physically quantified and visualized as a funnel-like energy landscape towards the native binding state with local roughness along the binding paths. FIGS. 2A-2D illustrate the theory of energy landscape. FIG. 2A is a schematic view of multiple docking complex conformations including the “native” pose and the decoys. FIG. 2B is an illustration of the density of states as a function of energy. The vertical direction corresponds to the energy level of a state, and each state is schematically illustrated as a line. FIG. 2C is the corresponding distribution of binding energies.

FIG. 2D is a schematic diagram of a funnel energy landscape illustrating the energy and entropy of various states of the protein-ligand binding.

The native conformation of the binding complex is the conformation with the lowest binding energy and the energies of the non-native conformations follow a statistical Gaussian distribution. A dimensionless quantity

$$\frac{δ E}{Δ E \sqrt{2 S}}$$

(termed as intrinsic specificity ratio (ISR), where δE is the energy gap between the native binding state and the average non-native binding states, ΔE is the energy variance of the non-native states and S is the configurational entropy) is defined to describe the magnitude of intrinsic specificity. A large ISR indicates a high level of discrimination of the native binding state from the non-native binding states, which means a high specificity. Therefore, ISR provides a quantitative measure of intrinsic specificity that can be determined without evaluating the conventional specificity by exploring the whole set of receptor or ligand universe.

Given the inherent limitations of current scoring functions and the demands for the practical way of evaluating specificity, a novel scoring function optimizing both intrinsic specificity and affinity is provided according to an embodiment of the present disclosure. The method of optimizing both intrinsic specificity and affinity is herein referred to specificity and affinity method, or the “SPA method.”

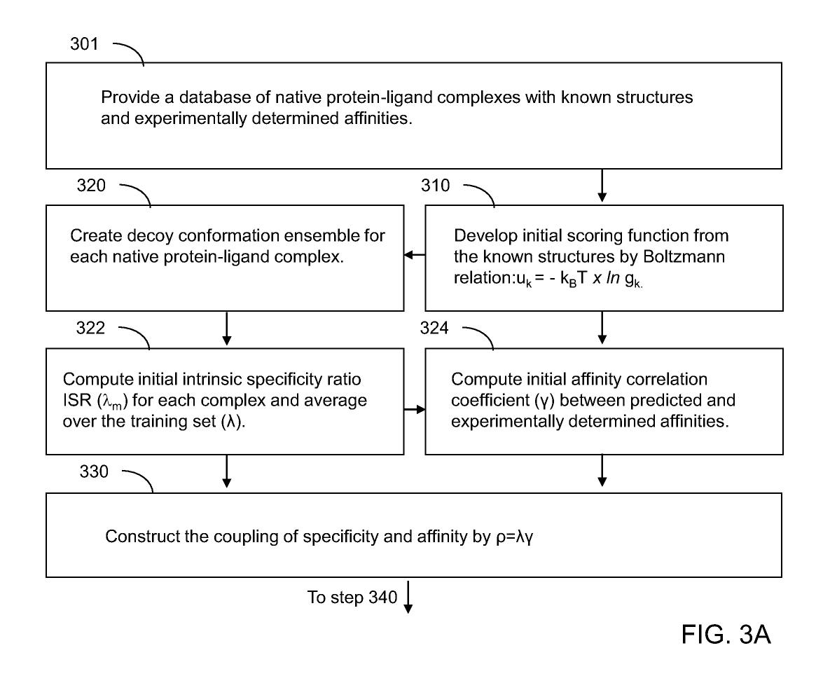

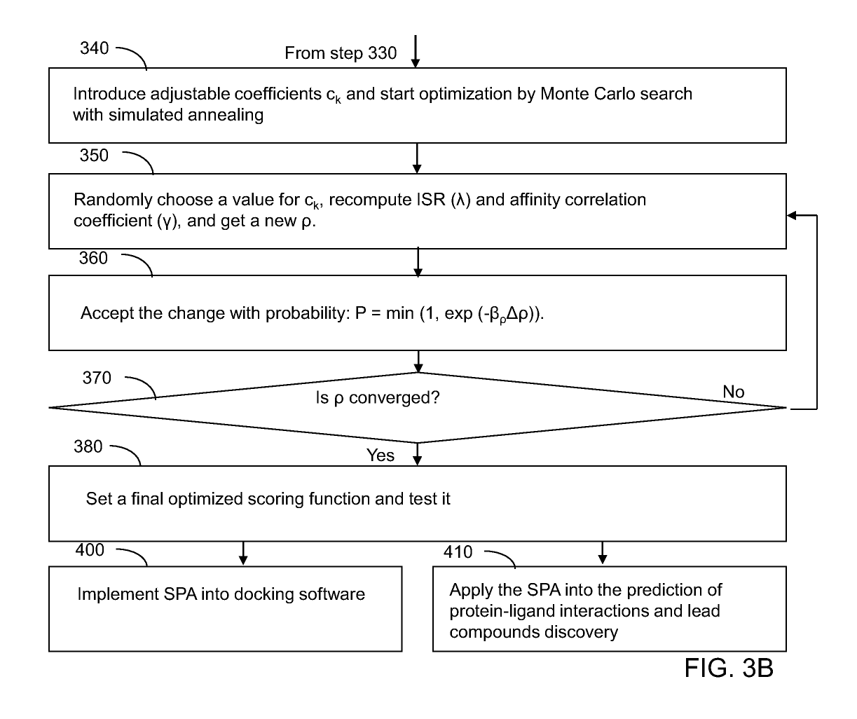

Referring to FIGS. 3A and 3B, the steps of the SPA method are illustrated in a flowchart. Referring to step 301, a database of native protein-ligand complexes with known structures and experimentally determined affinities is provided. The database can include any commercially available database and/or public database. The database can provide values of affinities as determined by experimentation for each pair of a ligand and a binding site.

A sub-sequence of steps 310 and 324 and a sub-sequence of steps 320 and 322 can be performed in parallel or in series.

Referring to step 310, distance-dependent potentials u (r) are derived. The initial atom-pair potential to be optimized is directly derived from the Boltzmann relation widely used in the knowledge-based statistical potentials, which is

uᵢⱼ(r)=−K_{B}Tln[gᵢⱼ(r)], (1)

where K_{B} is the Boltzmann constant, T is the absolute temperature, and In is the natural logarithm function, and gᵢⱼ(r) is the observed pair distribution function for the atom pair defined by the indices i and j and calculated by

$${g}_{ij} ( r ) = \frac{{f}_{ij}^{obs} ( r )}{{f}_{ij}^{ref} ( R )} , \qquad ( 2 )$$

fᵢⱼ^{obs}(r) is the observed number density of atom pair ij within a spherical shell between r and r+δr and the fᵢⱼ^{ref}(R) is the expected number density within the sphere of the reference state where there were no interactions between atoms. The former can be directly extracted from the database of protein-ligand complexes, while the later is obtained based on the approximation that the atom pair ij is uniformly distributed in the sphere of the reference state. Respectively, they are calculated as

$$\begin{matrix}{f}_{ij}^{obs} ( r ) = \frac{1}{M} {\sum }_{m = 1}^{M} \frac{{n}_{ij}^{m} ( r )}{V ( r )} , & ( 3 ) \\ {f}_{ij}^{ref} ( R ) = \frac{1}{M} {\sum }_{m = 1}^{M} \frac{{N}_{ij}^{m}}{V ( R )} , & ( 4 )\end{matrix}$$

where M is the number of protein-ligand complexes, nᵢⱼ(r) and Nᵢⱼ^{m} are the numbers of atom pair ij within the spherical shell and the reference sphere for a given protein-ligand complex m, where

$${N}_{ij}^{m} = {\sum }_{r} {n}_{ij}^{m} ( r ) , \\ and$$

$$V ( r ) = \frac{4}{3} π \{ {( r + Δ r )}^{3} - {r}^{3} \}$$

$$and$$

$$V ( R ) = \frac{4}{3} π {R}^{3}$$

are the volumes of the spherical shell and the reference sphere, respectively, where Δr is the bin size and R is the radius of sphere. As an illustrative example, Δr and R can be set as 0.3 Å and 7.0 Å, respectively. In total, there are 16 spherical shells with bin size 0.3 Å from the shortest radius 2.2 Å, which is the value to exclude the protein-ligand complexes with the steric atom clashes in PDBbind database.

In one embodiment, the initial potential can be extracted from any database of protein-ligand complex structures, while a good set of initial potentials can make optimizing search more efficient. An exemplary available database of protein-ligand complexes includes the refined set of 2011 version in PDBbind database. This database provides a comprehensive and high-quality collection of the experimentally determined biomolecular complexes with measured binding affinities which were filtered from the Protein Data Bank (PDB) by applying a series of criteria. Due to infrequent occurrence of metal atoms in the protein-ligand complexes, the complexes containing metal atoms are excluded and only the potentials between non-metal atoms are considered. 2316 protein-ligand complexes are remaining as our database to extract the initial potentials. Based on the definition of atom type by SYBYL, 22 atom types are used to cover protein-ligand interactions illustrated in Table 1. These atom types were converted from PDB files by BABEL, which is a software available to download.

TABLE 1
List of 22 atom types used for SPA

| Type | Description | Type | Description |
|---|---|---|---|
| C.3 | carbon sp3 | N.4 | quaternary nitrogen |
| C.2 | carbon sp2 | O.3 | oxygen sp3 |
| C.1 | carbon sp | O.2 | oxygen sp2 |
| C.ar | carbon aromatic | O.co2 | carboxy oxygen |
| C.cat | other carbons | S.3 | sulfur sp3 |
| N.3 | nitrogen sp3 | S.2 | sulfur sp2 |
| N.2 | nitrogen | S.O2 | sulfone sulfur |
| N.1 | nitrogen sp | P.3 | phosphorous sp3 |
| N.ar | nitrogen aromatic | F | fluorine |
| N.p13 | trigonal nitrogen | Cl | chlorine |
| N.am | nitrogen amide | I/Br | iodine/bromine |

A cutoff (=600) of Nᵢⱼ was employed to ignore the contribution from the atom pairs with statistically insufficient occurrences. This leads to 101 effective types of atom pairs in our calculation. In addition, if the atom pair has no occurrence in a particular spherical shell, the corresponding pair potential was set as the van der Waals interaction within this shell.

Referring to step 320, docking decoys are generated. As used herein, “decoys” refers to all possible configurations for a given protein-ligand complex. To calculate the intrinsic specificity ratio (ISR) for the optimization of SPA, enough conformations need to be sampled for each ligand docking to its specific protein receptor to explore the underlying binding energy landscape. For each protein-ligand complex, except the “native” protein-ligand conformation obtained from the PDB structure, all the conformational decoys of protein-ligand complexes can be generated by the molecular docking with a commercial software software such as AutoDock4.2. Given that enough sampling of binding decoys to generate binding energy landscape is dependent on the docking space that the ligand can explore, the grid box for ligand docking should be sufficiently large to cover the active site as well as significant portions of the surrounding surface. The edges of the grid box were set as five times as the radius of gyration of the naive conformation of ligand to guarantee the enough exploration of the active site, and the grid box was centered on the geometric center of the native pose with a grid spacing of 0.375.

Within the grid box, a population of conformational, rotational, and translational isomers can be stochastically generated from the starting structure of the ligand. The isomers can be docked with a conformational search method such as the Lamarckian genetic algorithm. During the search, the ligand can be considered conformationally flexible with its torsional bonds defined by the commercial software according to their chemical features. For example, for each protein-ligand complex, 500 separate docking runs can be performed which result in a database of 500 decoys for each complex. Other parameters can be set as the default values of the commercial software.

Subsequently, quantitative description of specificity and affinity is generated. To get a potential energy function which can maximize the binding specificity and the consistence between predicted and experimental affinity, the initial energy function is modified by introducing a set of adjustable parameters as the coefficients cₖ for the potentials of atom pair. The modified energy function MEF is defined by:

$$M E F = {\sum }_{k} {c}_{k} {f}_{k} {μ}_{k} . \qquad ( 5 )$$

The modified energy function represents a quantity derived from total intermolecular energy of a protein-ligand complex by providing different weighting to each interaction type of atom pairs, i.e., to each type of atom pair potentials classified by the types of atom pairs, and serves as the scoring function of the present disclosure. k stands for the type of atom pair interaction. In a specific illustrative example, there can be 1,616 types by multiplying the number of effective atom pairs (=101) and the number of shells (=16). fₖ represents the occurrences of the interaction type k between the protein and ligand, and uₖ is an alternative representation of uᵢⱼ(r) in equation 1. The coefficients cₖ are variable coefficients for the purpose of subsequent optimization for the interaction type k. The modified energy function MEF is an initial form of a scoring function, which is subsequently iteratively modified to generate a final form of the scoring function to be used for determining a score for each selected lead compound.

Referring to step 322, the intrinsic specific ratio (ISR) for a given protein-ligand complex m can be calculated as

$${λ}_{m} = α \frac{δ E}{Δ E} , \qquad ( 6 )$$

where α is a scaling factor which accounts for the contribution of the entropy to the specificity. Here, a approximately depends on the number of torsional bonds of the ligands. For example, α can be given by:

$$α ≅ \sqrt{\frac{1}{{n}_{tb}}} ,$$

in which n_{tb} is the average number of torsional bonds. δE is the energy gap between the energy of native conformation E_{N} and the average energy of ensemble of decoys <E_{D}>, and ΔE is the energy fluctuation or the width (mean square root deviation) of the energy distribution of the decoys, namely

δE=|E_{N}−<E_{D}>|, and (7)

ΔE=\sqrt{<E²_{D}>−<E_{D}>²}, (8)

in which < > means the average over the ensemble of decoys. When equations (5)-(8) are combined together, λₘ can be represented as

$${λ}_{m} = \frac{α \vert {\sum }_{k} {c}_{k} {u}_{k} ( {f}_{k}^{N} - 〈 {f}_{k} 〉 ) \vert}{{\sum }_{k} {\sum }_{l} {c}_{k} {c}_{l} {u}_{k} {u}_{l} ( 〈 {f}_{k} {f}_{l} 〉 - 〈 {f}_{k} 〉 〈 {f}_{l} 〉} , \qquad ( 9 )$$

where k and l are the indices of the interaction types. Once fₖ is computed for each interaction type in the decoys, one can easily compute the value of λₘ for a given set of cₖ.

The λₘ above is defined for a single protein-ligand complex. The potential energy function can be obtained that simultaneously makes λₘ values large enough for the whole protein-ligand complexes in the training set. A single objective function that reflects the λₘ values for all the protein-ligand complexes in the training set is generated. The Bolzmann-like weighted average of λₘ as the objective function is selected to represent a intrinsic specificity rate λ, which is given by:

$$λ = \frac{{\sum }_{m} {λ}_{m} exp ( {β}_{λ} {λ}_{m} )}{{\sum }_{m} exp ( {β}_{λ} {λ}_{m} )} \qquad ( 10 )$$

where β_{λ} is a constant value for weighting which is set as −0.1. The Bolzmann-like weighted average has the advantage over the normally used algebraic average since the protein-ligand complex with the smallest absolute value of λₘ contribute most to the objective function λ. To ensure that even the smallest λₘ will be large enough for discrimination of separating the “native” from non-native decoys, the smallest value of λₘ from the distribution pool among different protein-ligand binding complexes can be optimized. Therefore, Bolzmann-like weighted average is an appropriate combination of individual λₘ to achieve the objective that all the resulting protein-ligand complexes of the training set will be optimized with large λₘ value. This average approach has similar function as some other weighted average approaches used for optimizing energy function of protein folding.

Referring to step 324, initial affinity correlation coefficient γ between predicted and experimentally determined affinities is calculated. The quantitative measurements of the correlation between predicted and experimental affinity is depicted with Pearson's correlation coefficient by an affinity correlation coefficient γ, which is given by:

$$γ = \frac{{\sum }_{m} ( {E}_{m}^{p} - 〈 {E}_{m}^{p} 〉 ) ( {E}_{m}^{e} - 〈 {E}_{m}^{e} 〉 )}{\sqrt{{\sum }_{m} {( {E}_{m}^{p} - 〈 {E}_{m}^{p} 〉 )}^{2}} \sqrt{{\sum }_{m} {( {E}_{m}^{e} - 〈 {E}_{m}^{e} 〉 )}^{2}}} . \qquad ( 11 )$$

The predicted binding affinity Eₘ^{p} for the protein-ligand complex is represented by the binding scores calculated from the scoring function with a given set of cₖ. The experimentally measured affinity Eₘ^{e} is expressed in log K_{d} or log Kᵢ logic units, where K_{d} and Kᵢ are experimentally determined dissociation constant and inhibition constant respectively for the protein-ligand complex m.

Referring to step 330, the modified energy function MEF can be readily optimized once the initial potential energy and decoy ensembles are generated. In one embodiment, a combination parameter ρ representing a coupling of specificity and affinity is generated. The combination parameter ρ can be functionally dependent on the intrinsic specificity rate λ and the affinity correlation coefficient γ in any manner provided that the value of the combination parameter ρ increases for any increase in the intrinsic specificity rate λ and for any increase in the affinity correlation coefficient γ. In one embodiment, the combination parameter ρ can have the function form of ρ=Aλ^{p}γ^{q}+Bλ^{r}+Cγ^{s}+D, in which, A, B, C, p, q, r, and s are non-negative constants, and at least one of A, B, and C is a positive constant, at least one of p, q, r, s is a positive constant, and D is a constant. In one embodiment, the range of p can be from 0 to 10, the range of q can be from 0 to 10, the range of r can be from 0 to 10, and the range of s can be from 0 to 10. The aim of optimization here is to maximize the value of λ for variations in the specificity and the value of γ for variations in the affinity. In an illustrative embodiment, A, p, and q can be 1, and B, C, and D can be zero. In this case, the combination parameter ρ can have the functional form of ρ=λγ. The combination parameter is constructed to couple specificity and affinity and to enable evaluation of the performance of scoring function during the optimization.

Referring to step 340, adjustable coefficients cₖ are employed for the purpose of Monte Carlo simulation. The optimization is performed by Monte Carlo (MC) search with simulated annealing in the space of adjustable coefficients cₖ. The initial values of coefficients are set as 1.0 here, which means optimization of the scoring function starts from the modified energy function MEF obtained through equations (1)-(4).

Referring to step 350, a value for cₖ is chosen for each k. The new value for the selectivity parameter λ and the new value for the affinity correlation coefficient γ are calculated. Then, a new value for the combination parameter ρ can be calculated.

In one embodiment, a constraint can be applied to cₖ by restricting the value within the range from 0.2 to 5.0 times its initial value, which can be 1.0. This limitation can prevent the adjustable coefficients cₖ from becoming very large or small due to infrequent occurrences of the interactions. At each Monte Carlo (MC) step, one of the coefficients can be chosen at random and incremented or decremented by a differential change. In one embodiment, the differential change can have an absolute value in a range from 0.01 to 0.4, i.e., can be in a range from −0.4 to −0.01 or in a range from 0.01 to 0.4. In one embodiment, the differential change can have an absolute value in a range from 0.03 to 0.3. In another embodiment, the differential change can have an absolute value in a range from 0.1 to 0.25.

Referring to step 360, an error parameter E can be defined as E=−ρ. The error parameter E is minimized during the Monte Carlo simulation, which is equivalent to maximizing the combination parameter ρ. The resulting change in E is accepted with the probability

P=min(1,exp(−β_{ρ}ΔE)) (12)

Where min is a minimum function, and β_{ρ} is the inverse of the optimization temperature for the combination parameter ρ. This guarantees the chosen MC steps statistically prefer the low E and high combination parameter ρ. The temperature β_{ρ}⁻¹ decreases exponentially during the search and the starting temperature can be 0.5.

Referring to step 370, convergence of the combination parameter ρ is tested against a preset criteria. For example, the convergence criteria may include the total percentage change during a predetermined number of immediately preceding iterations. If the value of the combination parameter ρ is not converged, the process flow proceeds to step 350. If the value of the combination parameter ρ is converged, the process flow proceeds to step 380.

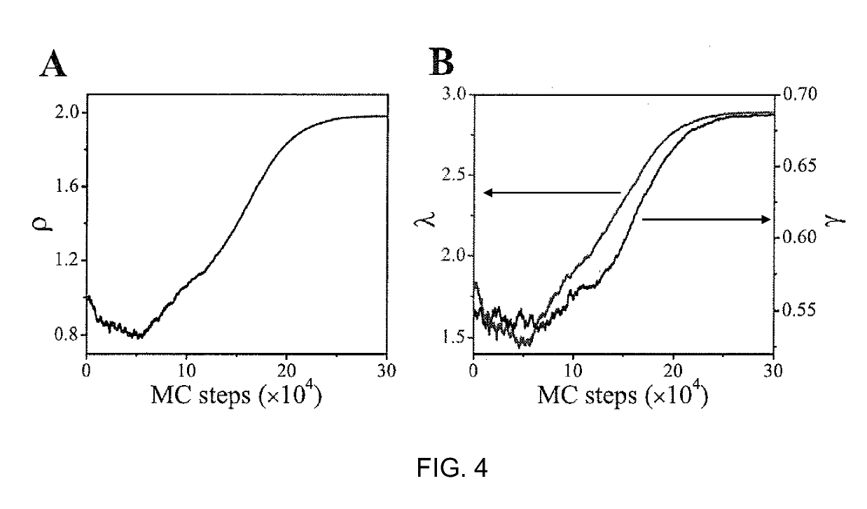

Referring to FIG. 4, an exemplary evolution and convergence of Monte Carlo search with simulated annealing for the optimization of SPA is shown. Graph A of FIG. 4 shows the evolution of the combination parameter ρ that is a product of the intrinsic specificity rate λ and the affinity correlation coefficient γ in an exemplary Monte Carlo run performed during the course of research leading to the present disclosure. Graph B of FIG. 4 shows evolution of the intrinsic specificity rate λ and the affinity correlation coefficient γ, demonstrating the maximization of both of the parameters. The search in the exemplary run converged well within 300,000 MC steps which suggests that a set of cₖ are found maximally optimized for the combination parameter ρ.

The convergence of both λ and γ indicates the optimized scoring function reaches the maximal performance of simultaneously quantifying the specificity and affinity. In the exemplary Monte Carlo (MC) run, for each MC search, 1500 protein-ligand complexes were randomly selected as the training set from the refined set of PDBbind database except the complexes in the test set. Five independent MC simulations were performed, and the average of correlation between the coefficients from different MC simulations is 0.80. This high correlation indicates optimization was successful and robust in the exemplary MC run.

At step 380, a final optimized scoring function is determined by accepting the latest values of the parameters obtained by the Monte Carlo simulation. Specifically, the finalized optimized scoring function is the modified energy function MEF in which the various coefficients have the values established by the Monte Carlo simulation.

Referring to step 400 of FIG. 3B, the optimized scoring function can be implemented in a docking software in order to predict the preferred orientation of a ligand binding to its protein target.

Referring to step 410 of FIG. 3B, the optimized scoring function can be employed for prediction of protein-ligand interactions and lead compounds discovery in addition to, or in lieu of, use in the docking software.

The novel scoring function SPA takes account of both specificity and affinity of protein-ligand binding. It represents a significant advance on previous scoring functions that only focused on affinity for development. The development strategy of SPA is simultaneously to reach the maximization of specificity and affinity for a large training set of “native” protein-ligand complexes with known structures and affinities. By introducing adjustable coefficients of potentials calibrated for optimizing with both specificity and affinity, the development of SPA offers an effective way to circumvent the calculation of the reference state which is a longstanding issue in the development of knowledge-based scoring functions.

Test results confirm that more reliable lead compounds can be screened by two dimensional screening with intrinsic specificity ratio ISR and affinity simultaneously. With the availability of rapidly increasing number of protein structures and the advent of high-performance computing system, computational virtual screening offers an effective and practical route to discovering new drug molecules, an alternative way of experimental high throughput screening. In the processes of virtual screening, the performance of the scoring function has a major impact on the quality of molecular docking predictions.

The outstanding performance of SPA makes it practical to be implemented in the docking software and widely applied in virtual screening for identifying the lead compounds with both affinity and specificity.

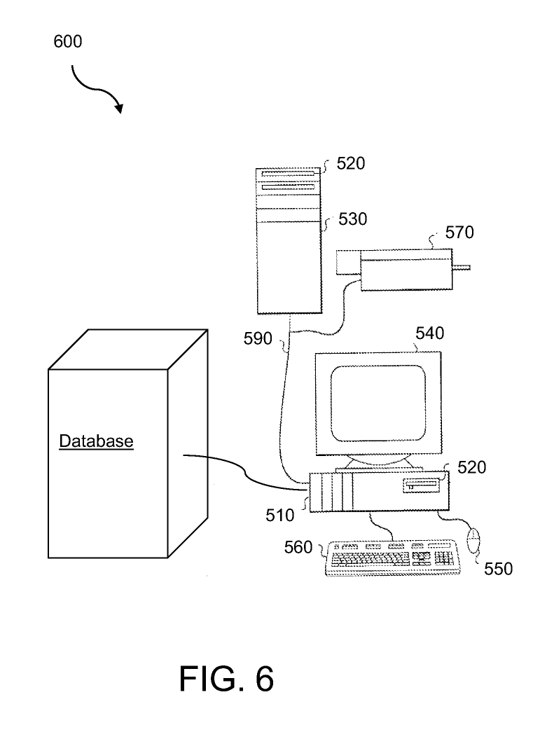

Referring to FIG. 6, an exemplary system 600 according to the present invention is shown. The exemplary system 600 includes a computing device that is configured to quantify characteristics of binding between a ligand onto the receptor performed by the program instructions. The computing device can include a memory and a processor device in communication with the memory. The program instructions can configure the computing device to perform the steps of embodiments of the present invention described above. The exemplary system 600 can be a computer-based system in which the methods of the embodiments of the invention can be carried out by an automated program of machine-executable instructions.

The computer-based system includes a processing unit 510, which can be a computing device and houses a processor device, a memory and other systems components (not shown explicitly in the drawing) that implement a general purpose or special purpose processing system, or can be a computer that can execute a computer program product. The computer program product can comprise data storage media, such as a compact disc, which can be read by the processing unit 510 through a disc drive 520. Alternately or in addition, the data storage media can be read by any means known to the skilled artisan for providing the computer program product to the general purpose processing system to enable an execution thereby. The exemplary system 600 can include a scanning and data acquisition unit. The memory and the processor device are provided within the processing unit 510. The scanning and data acquisition unit can be operated by employing the processor device and the memory by providing instructions to the processor device employing the program to enable the features of the present invention.

A data storage device are also provided herein that is programmable and readable by a machine and non-transitorily and tangibly embodying or storing a program of machine-executable instructions that are executable by the machine to perform the methods described. For example, the automated program can be embodied, i.e., stored, in a machine-readable data storage devices such as a hard disk, a CD ROM, a DVD ROM, a portable storage device having an interface such as a USB interface, a magnetic disk, or any other storage medium suitable for storing digital data.

The automated program can be embodied in a computer program product, which can perform the various steps of the present disclosure on a computing machine such as a computer or any other portable or non-portable computing device. The computer program product can comprise all the respective features enabling the implementation of the inventive method described herein, and which is able to carry out the method when loaded in a computer system. Computer program, software program, program, or software, in the present context means any expression, in any language, code or notation, of a set of instructions intended to cause a system having an information processing capability to perform a particular function either or both of the following: (a) conversion to another language, code or notation; and/or (b) reproduction in a different material form.

The computer program product can be stored on hard disk drives within the processing unit 510, as mentioned, or can be located on a remote system such as a server 530, coupled to the processing unit 510, via a network interface such as an Ethernet interface or wireless connection. A monitor 540, a mouse 550 and a keyboard 560 are coupled to the processing unit 510, to provide user interaction. A printer 570 can be provided for document input and output. The printer 570 is shown coupled to the processing unit 510 via a network connection, but can be coupled directly to the processing unit 510. All peripherals might be network coupled, or direct coupled without affecting the ability of the processing unit 510 to perform the method of the invention.

Tests

Test 1

The optimizing strategy for SPA method is to simultaneously reach the maximization of the performances on both the specificity and the affinity predictions of the training set. The process of a ligand binding to a protein can be thought as a conformational search guided by a scoring function, and the final destination is to look for the “native” binding pose with the best score. Whether the scoring function can select out the best-scored binding pose which resembles the one in the crystal structure closely determines the performance of the scoring function for identifying the “native” binding conformation. Normally, the root mean square deviation (RMSD) is taken as the measure of the structural closeness between the scored binding poses and the “native” binding conformation which is the ligand pose in the crystal structure here. If the RMSD value of the best-scored binding pose is less than a predefined cutoff, it is considered as a successful recognition of the “native” or “near-native” binding pose by the scoring function.

A practical way to validate the scoring function is to test its performance on the systems with known features. For SPA, two kinds of tests were taken. First, SPA was tested on a benchmark of protein-ligand complexes which is a high-quality set of 195 protein-ligand complexes selected out from the refined set of 2007 version of the PDBbind database. This benchmark was taken to test and compare the performance for a large collection of 16 scoring functions implemented in main-stream commercial softwares or available from academic research groups, which offers a reference for the comparison of SPA to other scoring functions. Each protein-ligand complex of the benchmark set was docked with the same parameter as the training set above to generate a binding energy landscape with decoy ensemble.

Molecular docking is basically a process of conformational search guided by a scoring function, and the final destination is to look for the “native” binding pose with best score. Whether the scoring function can select out the best-scored binding pose which resembles the one in the crystal structure closely enough determines the performance of the scoring function to identify the “native” binding conformation. Normally, the root mean square deviation (RMSD) is taken as the measure of the structural closeness between the scored binding poses and the “native” binding conformation which is the ligand pose in the crystal structure here. If the RMSD value of the best-scored binding pose is less than a predefined cutoff, it is considered as a successful recognition of the “native” or “near-native” binding pose by the scoring function.

To make a comparison with other scoring functions, the success rate for the benchmark set was calculated by SPA. Table. 2 lists the success rates of SPA as well as other 16 scoring functions under five different cutoffs (1.0, 1.5, 2.0, 2.5 and 3.0 Å). Clearly, SPA performs the best among all the scoring functions no matter what criterion of RMSD cutoff is taken, suggesting that SPA is very successful on the ability to identify “native” or “near-native” binding poses. Practically, besides the best-scored binding pose, multiple other binding poses with good scores could be selected out as putative “native” binding poses. Namely, it is possible in molecular docking to select a few top-ranked binding poses for further evaluation in hierarchical database screenings.

TABLE 2
Success rates of identifying “native” or “near-native”
conformations under different RMSD cutoffs.

| Scoring Functiona | 1.0 Å | 1.5 Å | 2.0 Å | 2.5 Å | 3.0 Å |
|---|---|---|---|---|---|
| SPA | 78.5 | 83.1 | 84.7 | 87.6 | 93.2 |
| GOLD/ASP | 69.3 | 79.2 | 82.5 | 85.2 | 89.1 |
| DS/PLP1 | 65.0 | 72.1 | 75.4 | 78.7 | 84.2 |
| DrugScore^{PDB}/PairSurf | 62.8 | 69.4 | 74.3 | 77.6 | 81.4 |
| GlideScore/SP | 54.6 | 64.5 | 73.2 | 76.0 | 84.7 |
| DS/LigScore2 | 54.1 | 62.8 | 71.6 | 75.4 | 80.3 |
| GOLD/ChemScore | 54.6 | 62.8 | 70.5 | 71.6 | 79.2 |
| GOLD/GoldScore | 51.9 | 61.2 | 68.9 | 72.1 | 80.9 |
| X-Score1.2/HMScore | 51.4 | 59.6 | 68.3 | 72.1 | 78.1 |
| SYBYL/F-Score | 54.6 | 61.7 | 64.5 | 68.3 | 73.8 |
| SYBYL/ChemScore | 40.4 | 49.7 | 60.1 | 65.6 | 71.6 |
| DS/Ludi2 | 41.5 | 48.6 | 57.4 | 61.7 | 67.2 |
| SYBYL/PMF-Score | 37.2 | 41.5 | 48.1 | 53.0 | 56.8 |
| DS/Jain | 25.7 | 36.1 | 44.8 | 54.6 | 64.5 |
| DS/PMF | 32.2 | 36.1 | 43.7 | 47.5 | 53.6 |
| SYBYL/G-Score | 25.1 | 35.5 | 41.5 | 48.6 | 56.3 |
| SYBYL/D-Score | 15.3 | 23.5 | 30.6 | 39.3 | 47.5 |

Table. 3 compares the success rates for the binding poses with top five scores under the commonly used criterion of RMSD cutoff (=2.0 Å). It can be seen that SPA yields more than 90% success rate to identify the “native” binding pose when the binding scores are considered from top one to five binding scores. It has comparable performance as other three top-ranked scoring function GOLD/ASP, DrugScorePDB/PairSurf and DS/PLP1. This result further validates the outstanding performance of SPA on “native” binding pose identification.

TABLE 3
Success rates of identifying the “native” or “non-native” conformation
among the top-scored binding poses under RMSD cutoff 2.0 Å.

| Scoring Function | One | Two | Three | Four | Five |
|---|---|---|---|---|---|
| SPA | 84.7 | 90.4 | 90.1 | 92.1 | 93.8 |
| GOLD/ASP | 82.5 | 90.2 | 92.3 | 94.0 | 95.6 |
| DrugScore^{PDB}/PairSurf | 74.3 | 89.1 | 91.8 | 93.4 | 95.1 |
| DS/PLP1 | 75.4 | 86.9 | 90.2 | 95.1 | 97.3 |
| DS/LigScore2 | 71.6 | 85.8 | 88.0 | 92.9 | 92.9 |
| GlideScore/SP | 73.2 | 83.1 | 86.9 | 90.2 | 93.4 |
| Gold/GoldScore | 68.9 | 79.8 | 85.2 | 87.4 | 89.6 |
| X-Score1.2/HMScore | 68.3 | 82.0 | 84.2 | 88.5 | 90.7 |
| GOLD/ChemScore | 70.5 | 78.7 | 82.0 | 85.2 | 86.9 |
| SYBYL/F-Score | 64.5 | 74.3 | 82.0 | 87.4 | 90.7 |
| SYBYL/ChemScore | 60.1 | 72.1 | 78.7 | 83.1 | 84.7 |
| DS/Ludi2 | 57.4 | 70.5 | 75.4 | 80.3 | 83.6 |
| DS/Jain | 44.8 | 63.9 | 70.5 | 76.0 | 79.2 |
| SYBYL/G-Score | 41.5 | 55.7 | 67.2 | 74.9 | 78.7 |
| SYBYL/PMF-Score | 48.1 | 61.7 | 63.4 | 66.7 | 71.0 |
| SYBYL/D-Score | 30.6 | 50.3 | 59.0 | 67.8 | 73.8 |
| DS/PMF | 43.7 | 53.0 | 56.8 | 63.9 | 67.2 |

A high success rate of identifying the “native” conformation also indicates that the binding poses structurally close to the “native” conformation have high binding scores in energetics. This structure-energy correlation is consistent with the concept of funnel-shaped energy landscape of protein-ligand binding, where the “native” binding conformation with lowest energy locates in the global minimum of the energy landscape. According to the energy landscape theory, it is promising that SPA with the highest success rate to identify the “native” conformation can search the global minimum with a fast convergence if it is applied to conformational sampling in molecular docking.

On the other hand, the ability to select native conformation out of the other decoys means we reach the specificity of discriminating the native binding mode from others.

In addition to the prediction of binding pose, the prediction of binding affinity is another important criterion to evaluate the performance of scoring function. In contrast to binding pose prediction which emphasizes on the discrimination of the “native” conformation from the “non-native” decoys for only one protein-ligand complex, the prediction of binding affinity relates to the ability of reproducing and comparison of binding affinities for different types of protein-ligand complexes. It determines the accuracy of binding scores predicted by the scoring functions. Since the scoring function usually can't reproduce the absolute values of binding affinities, the correlation between the predicted and experimental measured binding affinities is widely used to evaluate the accuracy of binding affinity prediction.

Table 4 lists the Pearson correlation coefficients (Cp) and Spearman rank correlation coefficients (Cs) respectively between the binding scores and the known binding constants for SPA and other 16 scoring functions. Cp is calculated by the same equation 14 and Cs is calculated by:

$${C}_{s} = 1 - \frac{6 {\sum }_{m} {( {r}_{m}^{p} - {r}_{m}^{e} )}^{2}}{M ( {M}^{2} - 1 )} \qquad ( 12 )$$

where rₘ^{p} and rₘ^{e} are the ranks of the complex m according to its binding scores determined by SPA and experimental binding constant respectively among the test set of M complexes. The Spearman rank correlation coefficient could give better index if the predicted and experimental measured binding affinities are not correlated in a linear manner.

TABLE 4
Correlations between the Predicted Binding affinity and
Experimentally Measured Binding affinity

| Scoring Functiona | C_{P} | C_{S} |
|---|---|---|
| SPA method | 0.668 | 0.733 |
| X-Score/HMScore | 0.644 | 0.705 |
| DrugScore^{CSD}/PairSurf | 0.569 | 0.627 |
| SYBYL/ChemScore | 0.555 | 0.585 |
| DS/PLP1 | 0.545 | 0.588 |
| GOLD/ASP | 0.534 | 0.577 |
| SYBYL/G-Score | 0.492 | 0.536 |
| DS/Ludi3 | 0.487 | 0.478 |
| DS/LigScore2 | 0.464 | 0.507 |
| GlideScore/XP | 0.457 | 0.432 |
| DS/PMF | 0.445 | 0.448 |
| GOLD/ChemScore | 0.441 | 0.452 |
| NHA | 0.431 | 0.517 |
| SYBYL/D-Score | 0.392 | 0.447 |
| DS/Jain | 0.316 | 0.346 |
| GOLD/GoldScore | 0.295 | 0.322 |
| SYBYL/PMF-Score | 0.268 | 0.273 |
| SYBYL/F-Score | 0.216 | 0.243 |

It can be seen from Table 4 that SPA obtains the best correlations of both Cp and Cs. Compared to other scoring functions, this performance of SPA is surprisingly excellent since no other scoring functions simultaneously rank on the tops for both the predictions of binding pose and binding affinity. For example, X-Score/HMScore performs well on the prediction of binding affinity but moderately on the prediction of binding pose (Shown in Table 2). Gold/ASP is able to identify the correct binding pose with a second high success rate whereas it is less successful to reproduce the binding affinities. It is worth noticing that only SPA and X-Score/HMScore achieve Cp over 0:6 which is much superior than other scoring functions.

The best performance of SPA on the prediction of both binding pose and binding affinity suggests that the optimization strategy calibrated to improve specificity and affinity for the development of SPA is successful. SPA is not only capable of discriminating the specific “native” conformation out of a large number of decoys by their scores but also accurately predicting the binding affinities of different protein-ligand complexes. This is encouraging to apply SPA in the virtual screening to identify the lead compounds for drug discovery with both affinity and specificity.

The ranking ability defined here is evaluated by ranking the binding scores of different ligands bound to the same target protein. This ability is highly related to the prediction of binding affinity which in contrast refers to the ranking of binding affinities for different proteinligand complexes. Among the three tests of the scoring functions, the ranking ability is most relevant to virtual screening which selects potential true ligands from a large database of compounds for a protein target. In this sense, the ranking ability is most important for structure-based drug design. The SPA is tested to rank the high-affinity ligand, a medium-affinity ligand, and a low-affinity ligand bound to a common type of protein for each family of the test set. The ranking is successful if the correct order of experimental determined affinities is predicted out of six possible ways.

Table 5 lists the success rates for all 16 scoring functions as well as SPA. SPA achieves success rate 54.2% which ranks second. The result further validates that a good scoring function capable of affinity prediction is also good at affinity ranking. On the whole, SPA outperforms all other scoring functions on the performances shown in Table 5.

TABLE 5
Success rates of ranking the affinity of different ligands
binding onto the same target

| Scoring Function | % | Scoring Function | % |
|---|---|---|---|
| X-Score/HSScore | 58.5 | DS/Jain | 41.5 |
| SPA | 54.2 | DS/PMF | 41.5 |
| DS/PLP2 | 53.8 | SYBYL/PMF- | 38.5 |
| | | Score | |
| DrugScoreCSD | 52.3 | GOLD/ChemScore | 36.9 |
| SYBYL/ChemScore | 47.7 | DS/LigScore2 | 35.4 |
| SYBYL/D-Score | 46.2 | GlideScore-XP | 33.8 |
| SYBYL/G-Score | 46.2 | NHA | 32.3 |
| GOLD/ASP | 43.1 | SYBYL/F-Score | 29.2 |
| DS/LUDI3 | 43.1 | GOLD/GoldScore | 23.1 |
| X-Score/HSScore | 58.5 | DS/Jain | 41.5 |

For the test of representative benchmark of protein-ligand complexes, SPA was compared to other 16 existing popular scoring functions with the performances. SPA achieves the highest success rate in identifying correct binding pose, yields the highest correlation coefficient in the prediction of binding affinity and also it performs best on ranking the affinities of different ligands binding to the same target. These significant improvements of performances over previous scoring functions is very encouraging to apply SPA in identify the lead compounds in drug discovery.

Test 2

Given the excellent performance of SPA on the benchmark test, the ability of SPA has been evaluated in real virtual screening test. The enzyme cyclooxygenase-2 (COX-2) was chosen as our target protein model which is the target of nonsteroidal anti-inflammatory drugs (NSAIDs) for reducing fever and inflammation, such as the most commonly-taken drug aspirin. The virtual screening for COX-2 is challenging, besides the importance to discriminate the inhibitors from the diversity set, it is more important to distinguish selective and nonselective inhibitors since selective inhibitors is much more potent to inhibit COX-2 than non-selective inhibitors. There should be differences on the stability and specificity among the selective, non-selective and the diversity set. Whether the differences can be evaluated according to their binding scores (E) and intrinsic specificity rate (λ) determines the performance of SPA in the applications of virtual screening.

SPA was applied on a target protein cyclooxygenase-2 (COX-2) for the virtual screening test. COX-2 is the inhibition target of nonsteroidal anti-inflammatory drugs (NSAIDs) for reducing fever and inflammation. A diverse set of 650 small molecules were selected from the NCI-Diversity database having molecular weights similar to that of the reference compound SC-558, with which the crystal structure of the COX-2 complex is available (PDB code 1CX2). 37 COX-2 selective and 20 nonselective inhibitors of NSAIDs are taken for the test of discrimination of inhibitors from the diversity set, as well as the discrimination of selective from non-selective inhibitors. The 37 COX-2 selective inhibitors include: ns-398, 1-745337, celecoxib, rofecoxib, dup-697, jte-522, valdecoxib, sc-58125, etoricoxib, meloxicam, etodolac, 1-776967, flosulide, 644784, bms-347070, cimicoxib, cis-stilbenes, ct-3, darbufelone, deracoxib, drf-4367, fr-188582, 1-758115, 1-768277, 1-778736, 1-784506, 1-804600, 1761066, parecoxib, pd-138387, pmi-001, rs57067, sc299, sc558, sc57666, svt-2016, and t-614. The 20 non-selective inhibitors include: indomethacin, sulindac-sulfide, ketoprofen, ketorolac, Ibuprofen, flurbiprofen, tenoxicam, piroxicam, bromfenac, carprofen, droxicam, fenoprofen, indoprofen, loxoprofen, meclofenamic-acid, oxaprozin, salicin, tiaprofenic-acid, zomepirac, and tolmetin. COX-2 selective inhibitors are specific to inhibit only COX-2, while COX-2 non-selective inhibitors inhibit both the COX-2 and its isoenzymes COX-1. Also, each ligand was docked to COX-2 to generate a binding energy landscape with 2000 decoy conformations, and the box size of docking was set as 100×100×100 grids centered at the compound SC-558. Since the crystal structures of COX-2 with the ligands in the diversity set are not available, by clustering the decoys the same as implemented in AutoDock software, the decoy with the lowest energy in the largest population cluster was considered as the “native” pose. To evaluate the performance of SPA in the virtual screening test, the evaluation methods including the receiver operating characteristic (ROC) curve, the enrichment test and the Kolmogorov-Smirnov test (KS test) were used to describe the performance of SPA and quantify the difference between selective, nonselective inhibitors and the diversity set.

The virtual screening test of SPA on a drug target COX-2 shows that it can successfully distinguish not only the inhibitors from the diversity set according to the binding scores, but also the selective inhibitors from non-selective inhibitors, the later discrimination is more demanding in the discovery of lead compounds for some drug targets.

In the enrichment test, the top 5% to 10% ranking of all the ligands are often considered as the interest in the virtual screening. The enrichment value means the percent of the drugs selected from all top ranked ligands according to the parameters. The enrichments for both selective and non-selective inhibitors are listed in Table 6. Table 6 clearly shows that selective inhibitors have both affinity quantifying the stability and specificity against the non-selective inhibitors, while the specificity is a better descriptor to discriminate the selective, non-selective inhibitors and the diversity set. Table 6 illustrates enrichments at top 5% and 10% of total ranked ligands.

TABLE 6
enrichments at top 5% and 10% of total ranked ligands for SPA

| | |
|---|---|
| Selective | Non-selective |

| | 5% | 10% | 5% | 10% |
|---|---|---|---|---|
| Affinity (E) | 35.1 | 43.2 | 0 | 5 |
| Specificity (λ) | 51.4 | 56.8 | 5.0 | 25.0 |

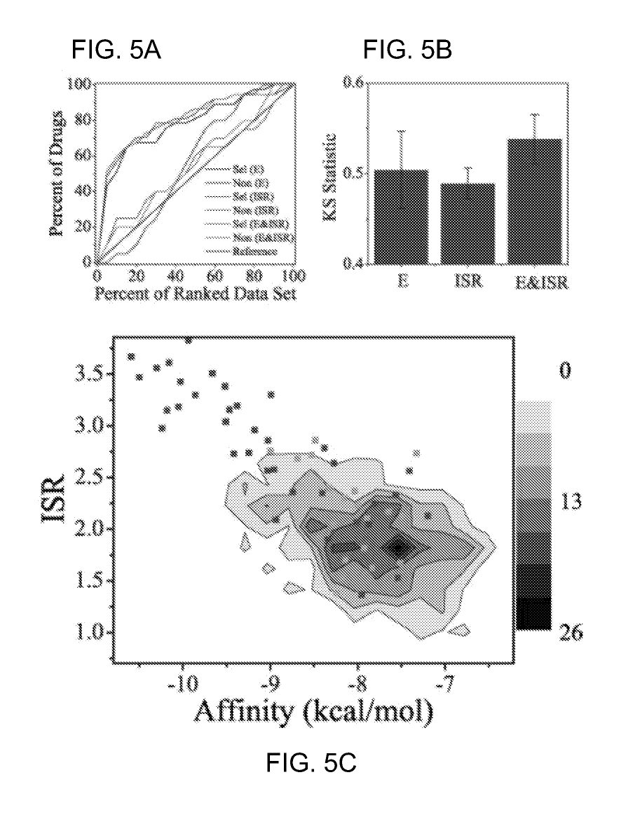

As seen from the enrichment curves in FIG. 5A, the selective drugs are obviously separated from the diversity set, while the non-selective drugs are weakly separated from the diversity set. This indicates that SPA method has the capacity to discriminate the drugs from the diversity set, especially the selective drugs from the diversity set. The weak discrimination of non-selective drugs from the diversity set may result from the fact that the non-selective drugs are not specific for COX-2 and have much lower potency than the selective drugs.

Referring to FIG. 5B, to further quantify the discrimination of selective drugs from non-selective drugs, the statistical discrimination KS test was calculated. The relative high values of KS statistic (higher than 40%) suggest significant differences between the selective drugs and the non-selective drugs in both affinity and specificity, and more obvious in terms of the combination of them. The KS statistic results demonstrate that SPA method is capable to discriminate selective drugs against non-selective drugs, which is important for selecting drug candidates with specificity against targets such as COX-2.

Based on the performance of SPA method on the screening, a two-dimensional projection of specificity and affinity is plotted in FIG. 5C for COX-2 with the diversity set of 650 selected compounds as well as its 37 selective and 20 non-selective drugs. The basin center with the highest density locates in the area with small ISR and low affinity, indicating that random compounds which have weak thermodynamic stability also generally do not have high specificity. Whereas, most of the selective drugs have large ISR and high affinity, and most of the non-selective market drugs tend to have relatively smaller ISR and lower affinity. It is worth noticing that a few drugs have values near the basin center in one parameter (ISR or affinity), but have larger values in another parameter, which suggests that specificity and affinity can be complementary in searching some specific drug candidates in virtual screening. These results validate that specificity is an important property of drug-target system.

Previously, both experimentally and computational initial screening techniques generally concentrated on the affinity selection for the lead compounds. The virtual screening test of SPA here demonstrated that the intrinsic specificity rates (λ) value is an appropriate indicator for the lead compounds selection. Experimentally, it is challenging to determine the binding specificity for a given target by measuring the affinities of all possible compounds with it. Computationally, it is practical to employ the scoring functions to carry out two dimensional virtual screening using both affinity and intrinsic specificity ratio in drug discovery, SPA is a good choice based on its performance. It is believed that that two dimensional screening could increase the true positive rate of identifying the lead compounds in the virtual screening for drug discovery with both affinity and specificity.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. A method of generating a scoring function for quantifying characteristics of protein-ligand bindings, said method comprising steps of:
generating an initial form of a scoring function that represents a quantity derived from a total intermolecular energy of each protein-ligand complex by providing different weighting to each type of atom pair potentials;
generating an average intrinsic specificity ratio that is a ratio of an energy gap between an energy of a native conformation and an average energy of said ensemble of decoys to a width of energy distribution of said ensemble of decoys;
generating an affinity correlation coefficient between a set of experimentally measured values of affinity and a set of predicted values of affinity as generated from said scoring function;
generating a combination parameter that strictly increases with any increase in said intrinsic specificity ratio and with any increase in said affinity correlation coefficient;
iteratively modifying said scoring function, said intrinsic specificity ratio, and said affinity correlation coefficient by changing values of said different weighting of atom pair potentials; and
finalizing a functional form of said scoring function by accepting final values of said different weighting when said iterative modification results in a convergence, wherein at least one step of said generation of said scoring function, said generation of said average intrinsic specificity ratio, said generation of said affinity correlation coefficient, said generation of said combination parameter, and said iterative modification of said scoring function, said intrinsic specificity ratio, and said affinity correlation coefficient is performed employing a computing system comprising one or more processors in communication with a memory.

2. The method of claim 1, wherein said width of energy distribution is a mean square root deviation of energies of said ensemble of decoys from an average energy of said ensemble of decoys.

3. The method of claim 1, wherein said set of predicted values of affinity is generated from said scoring function employing said different weighting to each atom pair potentials.

4. The method of claim 1, wherein said iterative modification of said scoring function, said intrinsic specificity ratio, and said affinity correlation coefficient comprises performing a Monte Carlo simulation.

5. The method of claim 1, wherein a value of said combination parameter p increases for any increase in said intrinsic specificity rate and for any increase in said affinity correlation coefficient.

6. The method of claim 5, wherein said combination parameter is given by the formula
ρ=Aλ^{p}γ^{q}+Bλ^{r}+Cγ^{s}+D,
wherein ρ is said combination parameter, λ is said intrinsic specificity ratio, γ is said affinity correlation coefficient, A, B, C, p, q, r, and s are non-negative constants, and at least one of A, B, and C is a positive constant, at least one of p, q, r, s is a positive constant, and D is a constant.

7. The method of claim 5, wherein said combination parameter is linearly proportional to a product of said intrinsic specificity rate and said affinity correlation coefficient.

8. A system for generating a scoring function for quantifying characteristics of protein-ligand bindings, said system comprising one or more processors in communication with a memory and is configured to run a computer program comprising steps of:
generating an initial form of a scoring function that represents a quantity derived from a total intermolecular energy of each protein-ligand complex by providing different weighting to each type of atom pair potentials;
generating an average intrinsic specificity ratio that is a ratio of an energy gap between an energy of a native conformation and an average energy of said ensemble of decoys to a width of energy distribution of said ensemble of decoys;
generating an affinity correlation coefficient between a set of experimentally measured values of affinity and a set of predicted values of affinity as generated from said scoring function;
generating a combination parameter that strictly increases with any increase in said intrinsic specificity ratio and with any increase in said affinity correlation coefficient;
iteratively modifying said scoring function, said intrinsic specificity ratio, and said affinity correlation coefficient by changing values of said different weighting of atom pair potentials; and
finalizing a functional form of said scoring function by accepting final values of said different weighting when said iterative modification results in a convergence.

9. The system of claim 8, wherein said width of energy distribution is a mean square root deviation of energies of said ensemble of decoys from an average energy of said ensemble of decoys.

10. The system of claim 8, wherein said set of predicted values of affinity is generated from said scoring function employing said different weighting to each atom pair potentials.

11. The system of claim 8, wherein said iterative modification of said scoring function, said intrinsic specificity ratio, and said affinity correlation coefficient comprises performing a Monte Carlo simulation.

12. The system of claim 8, wherein a value of said combination parameter ρ increases for any increase in said intrinsic specificity rate and for any increase in said affinity correlation coefficient.

13. The system of claim 12, wherein said combination parameter is given by the formula
ρ=Aλ^{p}γ^{q}+Bλ^{r}+Cγ^{s}+D,
wherein ρ is said combination parameter, λ is said intrinsic specificity ratio, γ is said affinity correlation coefficient, A, B, C, p, q, r, and s are non-negative constants, and at least one of A, B, and C is a positive constant, at least one of p, q, r, s is a positive constant, and D is a constant.

14. The system of claim 12, wherein said combination parameter is linearly proportional to a product of said intrinsic specificity rate and said affinity correlation coefficient.

15. A computer program product for generating a scoring function for quantifying characteristics of protein-ligand bindings, said computer program product embodied in a non-transitory machine readable medium and embodying a computer program, said computer program comprising steps of:
generating an initial form of a scoring function that represents a quantity derived from a total intermolecular energy of each protein-ligand complex by providing different weighting to each type of atom pair potentials;
generating an average intrinsic specificity ratio that is a ratio of an energy gap between an energy of a native conformation and an average energy of said ensemble of decoys to a width of energy distribution of said ensemble of decoys;
generating an affinity correlation coefficient between a set of experimentally measured values of affinity and a set of predicted values of affinity as generated from said scoring function;
generating a combination parameter that strictly increases with any increase in said intrinsic specificity ratio and with any increase in said affinity correlation coefficient;
iteratively modifying said scoring function, said intrinsic specificity ratio, and said affinity correlation coefficient by changing values of said different weighting of atom pair potentials; and
finalizing a functional form of said scoring function by accepting final values of said different weighting when said iterative modification results in a convergence.

16. The computer program product of claim 15, wherein said width of energy distribution is a mean square root deviation of energies of said ensemble of decoys from an average energy of said ensemble of decoys.

17. The computer program product of claim 15, wherein said set of predicted values of affinity is generated from said scoring function employing said different weighting to each atom pair potentials.

18. The computer program product of claim 15, wherein said iterative modification of said scoring function, said intrinsic specificity ratio, and said affinity correlation coefficient comprises performing a Monte Carlo simulation.

19. The computer program product of claim 18, wherein a value of said combination parameter ρ increases for any increase in said intrinsic specificity rate and for any increase in said affinity correlation coefficient.

20. The computer program product of claim 18, wherein said combination parameter is given by the formula
ρ=Aλ^{p}γ^{q}+Bλ^{r}+Cγ^{s}+D,
wherein ρ is said combination parameter, λ is said intrinsic specificity ratio, γ is said affinity correlation coefficient, A, B, C, p, q, r, and s are non-negative constants, and at least one of A, B, and C is a positive constant, at least one of p, q, r, s is a positive constant, and D is a constant.
